(19) United States
(12) Patent Application Publication
(10) Pub. No.: US 2012/0196169 A1
(43) Pub. Date: Aug. 2, 2012

(54) ENERGY STORAGE MODULE AND METHOD FOR MANUFACTURING THE SAME

(75) Inventors: Younghak JEONG, Gyeonggi-do (KR); Baekyun KIM, Gyeonggi-do (KR); Hyunchul JUNG, Gyeonggi-do (KR)

(73) Assignee: SAMSUNG Electro-Mechanics Co., Ltd.

(21) Appl. No.: 13/165,213

(22) Filed: Jun. 21, 2011

(30) Foreign Application Priority Data
Jan. 27, 2011 (KR) 10-2011-0008418

(51) Int. Cl. H01M 10/50; B23P 11/00; H01M 2/10

(52) U.S. Cl. 429/120; 429/158; 29/428

(57) ABSTRACT

Disclosed herein are an energy storage module including: battery units each formed by interconnecting electrode tabs on one side of two unit batteries and a sensing line; and a stacked structure receiving the battery units, and a method for manufacturing the same. In the energy storage module, a plurality of battery units each formed by previously interconnecting each electrode tab of the two battery cells and the sensing line are interconnected and each of the plurality of interconnected battery units is received in the stacked structure to form the battery module, thereby making it possible to effectively form the battery module without allowing the battery cells to be in direct contact with each other. Therefore, a plurality of pouch cells that are not easily fixed may be easily fixed, thereby making it possible to secure reliability of the energy storage module.

### CROSS REFERENCE(S) TO RELATED APPLICATIONS

This application claims the benefit under 35 U.S.C. Section 119 of Korean Patent Application Serial No. 10-2010-0008418, entitled “Energy Storage Module And Method For Manufacturing The Same” filed on Jan. 27, 2011, which is hereby incorporated by reference in its entirety into this application.

### BACKGROUND OF THE INVENTION

1. Technical Field

The present invention relates to an energy storage module and a method for manufacturing the same.

2. Description of the Related Art

A secondary battery, which is a kind of rechargeable energy storage, has been recently widely used as an energy source of a wireless mobile device. In addition, the secondary battery has been prominent as a power source of an electric vehicle (EV), a hybrid electric vehicle (HEV), etc., that have been suggested as a scheme for solving air pollution of an existing gasoline vehicle, diesel vehicle, etc., using a fossil fuel.

Small-sized mobile devices use one or more battery cells per one device. In contrast, due to necessity of high output and large capacity, middle and large-sized devices such as a vehicle, etc., use a middle and large-sized battery module in which a plurality of battery cells are electrically interconnected.

This middle and large-sized battery module is generally configured of a plurality of battery cells interconnected in series. The secondary battery is manufactured to have several shapes such as a cylindrical shape, a square shape. Each of the battery cells is configured to include an electrode assembly in which a positive electrode and a negative electrode are positioned, having a separator therebetween, a case including a space having the electrode assembly embedded therein, a cap assembly coupled to the case to close the case, and positive electrode and negative electrode tabs protruding to the cap assembly and electrically connected to current collectors of positive electrode and negative electrode plates included in the electrode assembly.

In the case of each battery cell in the square shaped battery, each unit battery is alternately arranged so that the positive electrode tab and the negative electrode tab, protruding to an upper portion of the cap assembly, are alternated with a positive electrode tab and a negative electrode tab of a neighboring unit battery, and a conductor is connected between screw processed negative electrode and positive electrode tabs through a nut, thereby forming a battery module.

Here, several to several tens of battery cells are interconnected, thereby forming a single battery module. Due to increase in volume of the battery module, volume in an external device in which the battery module is used is increased, thereby causing a limitation in design. Particularly, when the secondary battery module is used as a large capacity secondary battery for driving a motor of an electric cleaner, an electric scooter or a vehicle (an electric vehicle or a hybrid vehicle), an installation space of the battery module is narrow, such that there is a need to minimize the volume of the battery module.

Since a size and a weight of the battery module is directly related to a reception space, an output, and the like, of the middle and large-sized device, manufacturers have made an effort to manufacture a battery module as small and light as possible.

In addition, since each battery cell generates a large amount of heat therein during an operation thereof, the battery module configured of a plurality of battery cells should be capable of easily radiating the generated heat. Therefore, according to the related art, in order to radiate the heat within the battery module, several methods have been used. However, there still was a problem in that it is difficult to regularly arrange and interconnect the plurality of battery cells.

In addition, in the case of devices suffering from much impact, vibration, etc., from the outside, such as an electric bicycle, an electric vehicle, etc., since an electrical interconnection state and a physical coupling state between elements configuring the battery module should be stable and high output and large capacity should be implemented using a plurality of batteries, stability has also become important.

Therefore, in order to obtain power having high output and large capacity, there is a considerable need for a technique in which the plurality of battery cells configuring the middle and large-sized battery module are effectively interconnected, thereby making it possible to minimize the volume of the middle and large-sized battery module while maintaining the stability thereof.

### SUMMARY OF THE INVENTION

An object of the present invention is to provide an energy storage module in which a plurality of battery cells are effectively interconnected to thereby increase an cooling effect and stability while maintaining high output and large capacity.

Another object of the present invention is to provide a method for manufacturing an energy storage module.

According to an exemplary embodiment of the present invention, there is provided an energy storage module including: battery units each formed by interconnecting electrode tabs on one side of two unit batteries and a sensing line; and a stacked structure receiving the battery units.

An inner portion of the stacked structure may be penetrated through in a channel shape.

The channel of the inner portion of the stacked structure may be a path through which a cooling medium is ventilated.

Each layer configuring the stacked structure may be formed of at least one heat radiating member selected from a heating radiating plate and a cold plate.

The electrode tabs and the sensing line may be interconnected by heat fusing or physical coupling.

Electrode tabs on the other side of the battery units may be connected to neighboring electrode tabs, after the battery units are stacked in the stacked structure.

Each of the battery units stacked in the stacked structure may be connected to both ends of the stacked structure through a physical connection member from the top to the bottom.

The battery unit stacked on the outermost portion of the stacked structure may include a heat pad.

According to another exemplary embodiment of the present invention, there is provided a method for manufacturing an energy storage module, the method including: interconnecting electrode tabs of one side of two unit batteries and a sensing line in order to manufacture battery units; receiving the battery units in a stacked structure; interconnecting electrode tabs on the other side thereof that are not interconnected in the battery units; and connecting both ends of each unit battery stacked in the stacked structure through a physical connection member from the top to the bottom.

The method may further include attaching a heat pad to the outermost battery unit of the battery units, after receiving the battery unit in the stacked structure.

### BRIEF DESCRIPTION OF THE DRAWINGS

FIGS. 1A and 1B are views showing a process for manufacturing a battery unit by interconnecting unit batteries according to an exemplary embodiment of the present invention; and

FIG. 2 is a view showing a process for manufacturing a battery module by receiving the battery unit in a stacked structure.

### DESCRIPTION OF THE PREFERRED EMBODIMENTS

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

In addition, a thickness or a size of each layer will be exaggerated for convenience of explanation or clarity and like reference numbers will indicate the same components, in the drawings below. As used in the present specification, a term “and/or” includes any one or at least one combination of enumerated items.

In the present specification, although terms such as a first, a second, etc., are used to explain various members, components, areas, layers and/or portions thereof, these members, components, areas, layers and/or portions thereof are not limited to these terms. These terms are used only to distinguish one member, component, area, layer or a portion thereof from another member, component, area, layer or a portion thereof. Accordingly, a first member, a first component, a first area, a first layer, or a portion thereof described below may indicate a second member, a second component, a second area, a second layer, or a portion thereof.

A ‘unit battery’ or ‘battery cell’ used throughout the description of the present invention means a single battery in a state in which an electrode assembly having a structure of positive electrode/separator/negative electrode is received in a pouch shaped case.

In addition, a ‘battery unit’ used throughout the description of the present invention means a single unit in a form in which two unit batteries or two battery cells are interconnected.

Further, a ‘module’ used throughout the description of the present invention means a structure in which a plurality of unit batteries or a plurality of battery cells are interconnected or a structure in which a plurality of battery units are interconnected.

The present invention relates to an energy storage module formed by interconnecting a plurality of battery cells, and a method for manufacturing the same. In the energy storage module according to an exemplary embodiment of the present invention, electrode tabs on one side of two unit batteries and a sensing line are previously interconnected to form a single battery unit, a plurality of battery units are received in a stacked structure, and only electrode tabs on the other sides thereof are interconnected. Therefore, the energy storage module may be firmly fixed.

Each of the unit batteries has a structure in which an electrode assembly having a positive electrode, a negative electrode, a separator disposed therebetween, is seated in an external case and positive electrode and negative electrode tabs electrically connected to current collectors of the positive electrode and the negative electrode of the electrode assembly are exposed to an outer portion of the external case.

The external case is preferably a pouch shaped polymer case, and the positive electrode, the negative electrode, and the separator configuring each of the unit batteries are not specifically limited. However, the positive electrode and negative electrode tabs are formed in different directions.

Two unit batteries (hereinafter, referred to as a first unit battery and a second unit battery) having the above-mentioned structure are previously interconnected. Here, the interconnection is made by simultaneously interconnecting the electrode tabs of each unit battery and the sensing line. The unit batteries are preferably interconnected in parallel in order to be received in each layer of the stacked structure. Therefore, the positive electrode tab of the first unit battery, the negative electrode tab of the second unit battery and the sensing line are interconnected, such that the unit batteries may be easily received in the stacked structure.

The electrode tabs of each unit battery and the sensing line may be interconnected by fusing and welding methods using ultrasonic waves, a mechanical compressing method using a bolt/nut, or the like. In addition, they may be interconnected by a general method without being specifically limited. However, a method capable of minimizing connection resistance is preferably used.

The stacked structure for receiving the battery units therein, preferably, has a laminar structure so that the plurality of battery units may be received therein. The battery units are configured of two unit batteries; however, the battery units have a form in which they are spaced by a predetermined interval from each other. Therefore, each battery unit is inserted into each layer of the stacked structure, while facing each other, such that a single unit battery is substantially received in each layer. Since each unit battery may be received in the module without being in direct contact with each other, heat generated within the module during driving thereof may be effectively radiated.

In addition, an inner portion of each layer of the stacked structure may have a channel-shaped through structure. That is, since the inner portion of each layer is empty, the channel may be used as a path through which a cooling medium is ventilated. The channel has a minimum size capable of allowing the cooling medium to flow therethrough.

When the stacked structure is used as the path through which the cooling medium is ventilated, it is preferably integrally connected. In addition, in this case, each layer configuring the stacked structure may become a cold plate. Therefore, the stacked structure according to an exemplary embodiment of the present invention allows the cooling medium to flow therethrough, thereby making it possible to effectively cool the heat generated within the battery.

Each layer of the stacked structure according to an exemplary embodiment of the present invention is preferably disposed as close as possible in order to reduce the volume of the module, while including each unit battery. Therefore, each layer is preferably maintained so as to be spaced by only an interval capable of receiving each unit battery therein. A material of the stacked structure is not specifically limited if it is a material capable of satisfying this structure. Therefore, any one of polymer materials or metal materials having excellent physical property may be used.

The electrode tabs on one side of the battery units are already interconnected during manufacturing of the battery units. Therefore, when the battery units are received in each layer of the stacked structure, electrode tabs on the other side thereof are connected to neighboring electrode tabs. Here, the neighboring electrode tabs may also be interconnected by the same method as described above.

According to an exemplary embodiment of the present invention, the electrode tabs on one side of the battery units and the sensing line are previously interconnected and are received in the stacked structure, and the electrode tabs on the other side thereof are then interconnected, thereby making it possible to simplify a process.

Hereinafter, a method for manufacturing an energy storage module according to an exemplary embodiment of the present invention will be described. A method for manufacturing an energy storage module according to an exemplary embodiment of the present invention may include interconnecting the electrode tabs of one side of the two unit batteries and the sensing line in order to manufacture the battery units, receiving the battery units in the stacked structure, interconnecting electrode tabs on the other side thereof that are not interconnected in the battery units, and connecting both ends of each battery unit stacked in the stacked structure through a physical member from the top to the bottom.

The electrode tabs of the two unit batteries are preferably interconnected in parallel. Here, the electrode tabs of the two unit batteries and the sensing line are simultaneously interconnected. Each battery unit manufactured as described above is received in the stacked structure having multiple layers, while facing each other, such that a single unit battery is substantially stacked in each layer. The stacked structure having the multiple layers is formed to have a through structure including the channel, which is an empty space formed therein, such that the cooling medium may also be injected thereinto and be ventilated therethrough. In this case, each layer of the stacked structure may have a mutually connected shape.

In addition, after the battery units are received in the stacked structure, a heat pad may be additionally attached to the outermost battery unit of the battery units. The heat pad is preferably formed on at least any one of the unit battery positioned on the top of the stacked structure and the unit battery positioned on the bottom thereof. The heat pad fixes the unit batteries at the top and the bottom, thereby making it possible to effectively radiate the heat generated within the battery, while improving an adhesion.

Finally, both ends of the stacked structure are connected through the physical member from the top to the bottom, such that the stacked structure may be fixed. The physical member serves to completely tighten the stacked structure having the battery units received therein. As the physical member, a bolt/nut may be used. However, the physical member is not specifically limited thereto.

Hereinafter, a process for manufacturing an energy storage module according to an exemplary embodiment of the present invention will be described in detail in order to assist in the understanding of the present invention. Examples of the present invention are provided in order to more completely explain the present invention to those skilled in the art. Examples below may be modified in several different forms and does not limit a scope of the present invention. Rather, these Examples are provided in order to make this disclosure more thorough and complete and completely transfer ideas of the present invention to those skilled in the art.

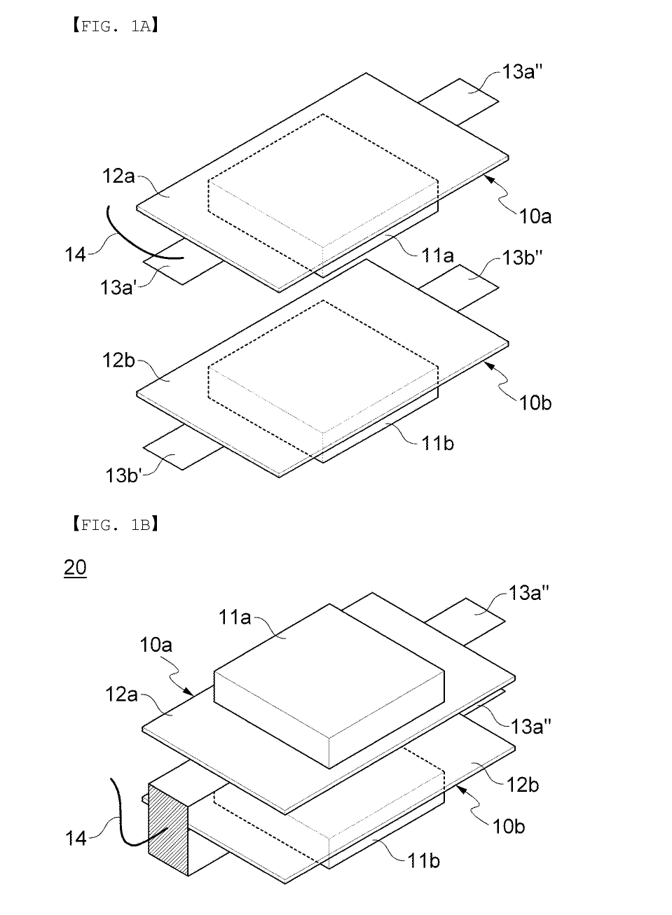

FIGS. 1A and 1B show a process for manufacturing a battery cell according to an exemplary embodiment of the present invention. A process for manufacturing a battery cell according to an exemplary embodiment of the present invention will be described in detail with reference to FIGS. 1A and 1B.

According to an exemplary embodiment of the present invention, a first unit battery 10a and a second unit battery 10b are first interconnected, wherein each of the unit batteries 10a and 10b is formed in a state in which electrode assemblies 11a and 11b including a positive electrode, a separator, and a negative electrode are packaged by the pouch-shaped cases 12a and 12b. In addition, each of the positive electrode and negative electrode tabs 13a′, 13a″, 13b′, and 13b″ extended from current collectors of each electrode are exposed to the outside of the pouch-shaped cases 12a and 12b.

According to an exemplary embodiment of the present invention, the electrode tab 13a′ of the first unit battery 10a, the electrode tab 13b′ of the second unit battery 10b, and the sensing line 14 are interconnected (oblique line) by a method such as ultrasonic wave fusing and welding methods, etc., thereby manufacturing the battery unit 20 connected as shown in FIG. 1B. The electrode tab 13a′ and the electrode tab 13b′ have polarity opposite to each other.

Each of the battery units 20 manufactured as described above is received in each layer of the stacked structure 30. The stacked structure 30 has multiple layers 31, and the battery units 20 are stacked therein so that a single unit battery is received in each layer. Each of the layers 31 may have the through structure having the channel 32 formed in the inner portion thereof so as to have the empty space formed in the inner portion thereof. Therefore, the cooling medium may also be selectively injected into and ventilated through the channel.

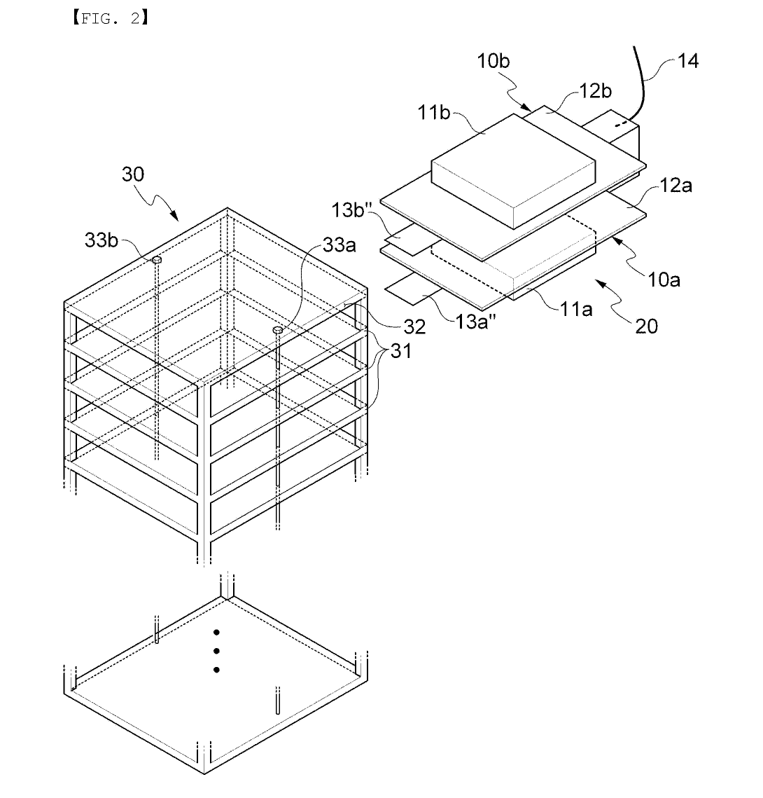

As shown in FIG. 2, since the electrode tabs 13a′ and 13b′ on one side of each unit battery are already interconnected, the electrode tab 13a″ on the other side thereof is connected to the electrode tab 13b″ of the neighboring unit battery.

After each battery unit is received in the stacked structure, the heat pad may also be attached to the unit batteries positioned at the top and the bottom of each battery unit.

Finally, after the battery units are received in the stacked structure, both ends of the stacked structure may be fixed through predetermined members 33a and 33b, for example, the bolt and the nut, from the top to the bottom, so that a hole penetrates through a portion thereof.

In the case of the energy storage module manufactured through the process as described above, a pouch cell that is not easily fixed may be easily fixed, thereby making it possible to secure reliability of the energy storage module.

The energy storage according to the exemplary embodiment of the present invention may be used in a power tool; an electric vehicle including an electric vehicle (EV), a hybrid electric vehicle (HEV), and a plug-in hybrid electric vehicle (PHEV); an electric two-wheeled vehicle including an E-bike and an E-scooter; an electric golf cart, and the like, receiving electric power from an electric motor to be moved; however a use range of the energy storage according to the exemplary embodiment of the present invention is not limited thereto.

With the energy storage module according to the exemplary embodiment of the present invention, a plurality of battery units each formed by previously interconnecting each electrode tab of two battery cells and the sensing line are interconnected and each of the plurality of interconnected battery units is received in the stacked structure to form the battery module, thereby making it possible to effectively form the battery module without allowing the battery cells to be in direct contact with each other.

In addition, the battery units are received in the stacked structure formed of the cold plate or a heat radiating plate, and the inner portion of the stacked structure has the channel-shaped through structure to effectively transfer the heat generated within the energy storage device, thereby making it possible to improve the cooling effect.

Further, the tabs on one side of the battery units are previously interconnected, the battery units having the interconnected tabs are received in the stacked structure, and only the tabs on the other side thereof are interconnected through a single connection member, such that a plurality of pouch cells that are not easily fixed may be easily fixed, thereby making it possible to improve the stability of the energy storage module and secure reliability thereof.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An energy storage module comprising:
battery units each formed by interconnecting electrode tabs on one side of two unit batteries and a sensing line; and
a stacked structure receiving the battery units.

2. The energy storage module according to claim 1, wherein an inner portion of the stacked structure is penetrated through in a channel shape.

3. The energy storage module according to claim 2, wherein the channel of the inner portion of the stacked structure is a path through which a cooling medium is ventilated.

4. The energy storage module according to claim 1, wherein each layer configuring the stacked structure is formed of at least one heat radiating member selected from a heating radiating plate and a cold plate.

5. The energy storage module according to claim 1, wherein the electrode tabs and the sensing line are interconnected by heat fusing or physical coupling.

6. The energy storage module according to claim 1, wherein electrode tabs on the other side of the battery units are connected to neighboring electrode tabs, after the battery units are stacked in the stacked structure.

7. The energy storage module according to claim 1, wherein each of the battery units stacked in the stacked structure is connected to both ends of the stacked structure, through a physical connection member, from the top to the bottom.

8. The energy storage module according to claim 1, wherein the battery unit stacked on the outermost portion of the stacked structure includes a heat pad.

9. A method for manufacturing an energy storage module, the method comprising:
interconnecting electrode tabs of one side of two unit batteries and a sensing line in order to manufacture battery units;
receiving the battery units in a stacked structure;
interconnecting electrode tabs on the other side thereof that are not interconnected in the battery units; and
connecting both ends of each unit battery stacked in the stacked structure through a physical connection member from the top to the bottom.

10. The method according to claim 9, further comprising attaching a heat pad to the outermost battery unit of the battery units, after receiving the battery unit in the stacked structure.
